(19) United States
(12) Patent Application Publication
(10) Pub. No.: US 2026/0064276 A1
(43) Pub. Date: Mar. 5, 2026

(54) DYNAMIC ADDRESS-BASED DATA RELIABILITY

(71) Applicant: Apple Inc., Cupertino, CA (US)

(72) Inventors: Robert E. JETER, Santa Clara, CA (US); Jingkui ZHENG, Sunnyvale, CA (US)

(21) Appl. No.: 18/935,952

(22) Filed: Nov. 4, 2024

Related U.S. Application Data
(60) Provisional application No. 63/691,225, filed on Sep. 5, 2024.

(51) Int. Cl. G06F 3/06

(52) U.S. Cl. CPC G06F 3/0611; G06F 3/0659; G06F 3/0673

(57) ABSTRACT

A memory subsystem is disclosed. The memory subsystem includes a memory controller and a memory having at least a first rank and a second rank, the first and second ranks being separately addressable from one another. The memory controller is configured to, in response to receiving a write command, determine if corresponding data is to be written to a single rank or to multiple ranks. When written to multiple ranks, data can be read from the multiple ranks, with comparisons being performed for error checking. Data associated with some write commands may be written to only a single rank, forgoing error protection.

### CROSS-REFERENCE TO RELATED APPLICATIONS

The present application claims the benefit of U.S. Provisional Application No. 63/691,225, entitled “DYNAMIC ADDRESS-BASED DATA RELIABILITY,” filed Sep. 5, 2024, the content of which is incorporated by reference herein in its entirety for all purposes.

### FIELD

This disclosure is directed to computer systems, and more particularly, to protecting data in memory subsystems.

### BACKGROUND

Dynamic random access memory (DRAM) utilized in various types of computer systems is susceptible to random errors. These errors may be result of memory malfunction, transient conditions, lack of refresh, and so on. To protect data from these errors, error correction code (ECC) data may be used. ECC data may be computed based on the actual data, and may comprise extra bits associated therewith. These extra bits may be used, for example, to check odd or even parity to determine if an error is present in the data. In some cases, single-bit or even double-bit errors may be correctable using ECC data. The ECC data may be in memory, e.g., along with associated data.

### BRIEF DESCRIPTION OF THE DRAWINGS

FIG. 1 is a block diagram depicting one embodiment of a memory subsystem.

FIG. 2 is a diagram illustrating additional details of an embodiment of a memory subsystem.

FIG. 3 is a block diagram of one embodiment of a memory controller.

FIG. 4 is a flow diagram of one embodiment of a method for operating a memory subsystem.

FIG. 5 is a flow diagram of another embodiment of a method for operating a memory subsystem.

FIG. 6 is a block diagram of one embodiment of a system including a memory controller according to the disclosure.

FIG. 7 is a diagram illustrating example applications for various embodiments of a memory subsystem according to the disclosure.

FIG. 8 illustrates an example of a non-transitory computer-readable storage medium that stores circuit design information.

### DETAILED DESCRIPTION

Dynamic random access memory, or DRAM, is susceptible to random errors in which the value of a stored bit is “flipped,” from its original value, e.g., from a logic 0 to a logic 1. These errors may occur for various reasons, such as transitory conditions, lack of refresh and so on. Accordingly, error protection may be implemented in memory subsystems to detect and correct errors.

A commonly used error detection and correction scheme utilizes an error correction code (ECC) for each unit of data stored. For example, each byte of data in one example system may be protected by an ECC. An ECC for a given unit of data may include one or more bits appended to the data that can be used to check the data for errors. The ECC may also enable the determination of which bits are in error to allow for its correction. Other error correction schemes, such as the use of checksums, are also used in some implementations.

The use of various error correction schemes requires the storing of additional data. Typically, when error correction is used, all data is protected, with extra storage space used to store the error correction data (e.g., the ECCs). However, such error correction schemes make no distinction with regard to the criticality of the data. Thus, extra storage space is consumed irrespective of whether protecting the corresponding data is critical or not.

The present disclosure makes use of the insight that various units of data may have varying levels of criticality. To this end, the disclosure contemplates a memory subsystem having multiple portions (such as a dual-rank memory subsystem) in which some data is protected while other data is not protected. In an example dual-rank system in which a memory circuit includes a first rank and a second rank, protected data may be written to a memory address in one of the ranks and duplicated in the other rank. Unprotected data, meanwhile, is stored in only a single rank.

A memory controller according to the disclosure may, in response to receiving a write command, determine whether a unit of data is to be stored in a single rank or mirrored (duplicated) by storing the same data in both ranks of a dual-rank system. In one embodiment, the memory controller makes this determination based on a value of a code comprising extra bits of a memory address associated with the write command. Thus, data that is written into both ranks is protected by its duplication. Meanwhile, the methodology disclosed herein may forego error protection for data that is written to only a single rank.

The code associated with the address may also be used to determine how data is read from memory. When data is duplicated into both ranks, the code may indicate one of a number of possible read options. For example, the code may indicate an optimized read to cause the reading of duplicated data from the rank with the lowest estimated latency. In another example, the code may indicate that duplicated data is to be read from both ranks and compared to check for the presence of errors.

While various examples discussed herein are directed to a dual-rank memory subsystem, the disclosure contemplates memory subsystems using more than two ranks or other types of organization. In such embodiments, protected data may be written to more than two portions of a memory. The disclosure further contemplates that the number of portions to which protected data is written may vary from one instance to the next based on varying levels of criticality of the data. Protecting only some but not all data may result in additional memory space that would otherwise be used to store ECCs.

Various embodiments of the disclosed subject matter are now discussed in further detail. The discussion begins with various embodiments of a memory subsystem that includes a multi-rank memory circuit and a memory controller. Methods of operating a memory subsystem according to the disclosure for both write and read operations are also described. Thereafter, the discussion moves to an example of a device which may include various portions of the memory subsystem of the present disclosure. Examples of a system which may utilize the disclosed memory subsystem are also described. The detailed description concludes with an example of a computer readable medium according to the disclosure.

### Memory Subsystem

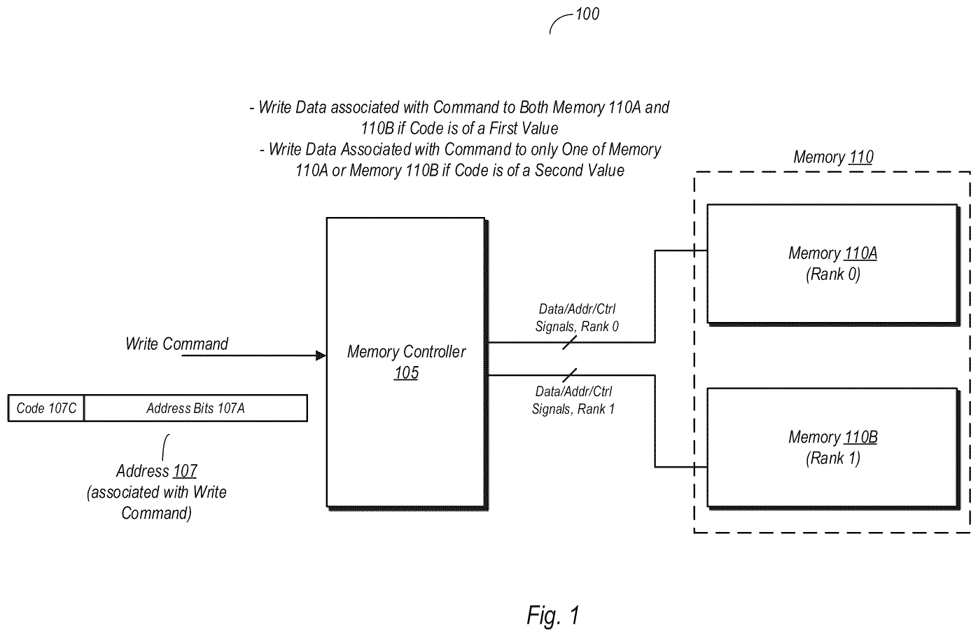

FIG. 1 is a block diagram depicting one embodiment of a memory subsystem. In the embodiment shown, memory subsystem 100 includes a memory controller 105 and a memory circuit 110. As shown here, memory 110 is a dual-rank memory, having a first rank 110A (Rank 0), and a second rank 110B (Rank 1). First rank 110A and second rank 110B each include one or more memory chips, and are separately and independently addressable. Furthermore, first rank 110A and second rank 110B may be accessed concurrently by memory controller 105 for both read and write operations. Accordingly, memory operations carried out by memory controller 105 with the two memory ranks may be interleaved and/or overlapped with one another, via separate data, address and control signal paths.

While memory 110 in the embodiment shown is a dual-rank memory, it is noted that the disclosure is not limited in this manner. For example, the disclosure contemplates quad-rank (four ranks) and octal-rank (eight ranks) memory in addition to the dual-rank memory of FIG. 1. The disclosure further contemplates other types of memory organizations within the context of the present subject matter.

Memory subsystem 100 in the embodiment shown supports mirroring of some data, wherein mirroring is defined here as duplicating a unit of data in both ranks (or replicating the data in multiple ranks or within other portions of other memory organizations). Duplicating a unit of data may provide protection for that data against errors. In various embodiments, no error protection is provided for unmirrored data. The mirroring in various embodiments is carried out on a command-by-command basis in which a decision to mirror or not is made for each unit of data associated with a particular write command. The mirroring may be carried out in various ways, including by a memory controller, by other circuits (e.g., a processor core) or even by software (e.g., operating system software), and may depend on various factors such as performance, reliability of particular memory channels/ranks, and so on.

Determining whether data is to be mirrored or not is based on a code 107C that is received as part of an address 107 (that also includes address bits 107A). Address bits 107A are used to determine a particular location in one of the ranks in which to store the data associated with the write command. Code 107C is used to determine whether the data is to be mirrored, and may also determine certain parameters for reading the data, as will be discussed in further detail below. The code 107C may be comprised of extra bits of the address (e.g., RAS, or row address strobe bits, or other bits that are unused). Furthermore, the code may take on at least two different values. A first value indicates that the data associated with a given write command is to be mirrored, while a second value indicates that the data is not to be mirrored. The code 107C is read by memory controller 105, which includes logic for interpreting the code as well as for carrying out the indicated write operation on the data.

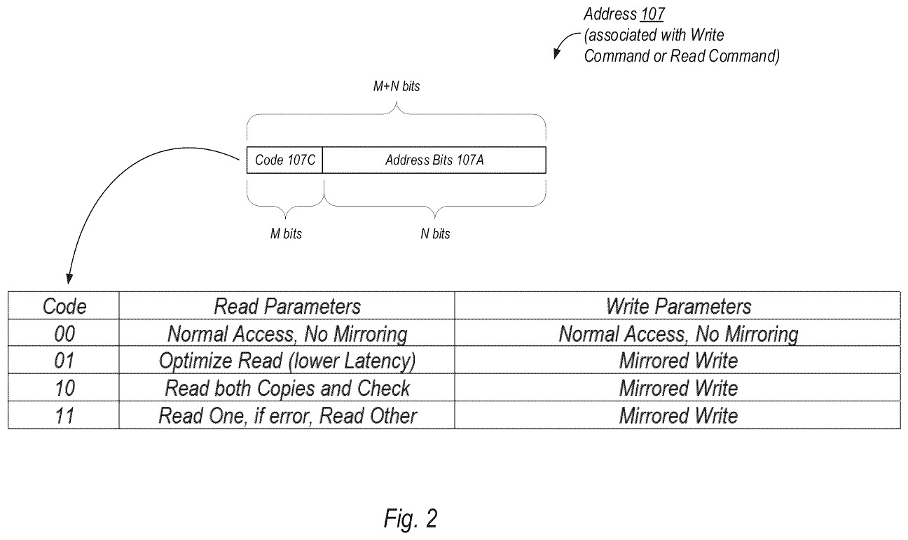

FIG. 2 is a diagram illustrating additional details of an embodiment of a memory subsystem. More particularly, FIG. 2 illustrates read and write parameters associated with a code 107C according to one embodiment of a dual-rank memory subsystem.

In the example shown, the code 107C includes two bits. A code of 00 indicates that the data associated with the read and write commands is not to be mirrored and read from memory using a normal access, or reading from a single address where the data is stored. For all other codes, 01, 10, and 11, the write parameters indicate that the data is to be mirrored. In a dual-rank memory subsystem, this means the data associated with a particular write command is written into both ranks.

When the code indicates a mirrored write, the corresponding data can be subsequently read according to a specific code value. For a code value of 01 in this example, the reading of data is optimized for lower latency. Optimizing for lower latency may be carried out in various ways. For example, in many dual-rank memory subsystems, the two ranks may be accessed concurrently, and at any given time there may be commands (read and/or write) pending for both ranks. Based on the pending commands for each ranks, the memory controller may estimate which of the two ranks will provide the mirrored data with lower latency, choosing that rank from which to read the data. In some implementations, one rank may be capable of providing data at a lower latency than the other rank. Accordingly, if other factors are essentially equal, the memory controller may, in such an implementation, choose to read the data from the rank capable of the lower latency. Embodiments are further possible and contemplated in which historical latency data is tracked over some period, with the memory controller making an estimate of which of the two ranks can provide the mirrored data with the lowest latency. In some embodiments, a memory controller may perform workload balancing and thus choose to read data from a rank that is less busy than other ranks.

For another code value, 10, the memory controller may read the mirrored data from both ranks and perform a check by comparing the two copies. This may indicate whether an error is present. If the two copies of the data do not match, additional checks may be conducted to determine which of the copies is correct. Such checks may involve an ECC, a checksum, or some other metadata. The copy of the data determined to be incorrect may be written back to the memory at its correct value.

A code value of 11 in the illustrated example indicates that mirrored data is to be read from one of the ranks and checked for an error. If no error is present, the data is provided to its requestor. If an error is present, the data is read from the other one of the ranks, and checked for an error as well, being provided to its requestor in response to being determined to be error free. The copy of the data in which the error was detected may be re-written at the correct value. In the case where both copies of the data are determined to be erroneous, the data may be corrected based on the error check if possible.

The determination of whether or not a particular unit of data is to be mirrored may be made in various ways. In one embodiment, a particular application or thread running on the computer that includes the memory subsystem may make the determination whether particular data is to be mirrored. In another embodiment, the determination to mirror or not may be made by an operating system. Some embodiments may utilize a combination of these two factors. The disclosure further contemplates that determinations of whether to mirror data or not may be made based in part on system workload (and thus, memory usage), wherein more data may be mirrored when the workloads and memory usage are lighter.

As the disclosure contemplates memory subsystems other than dual-rank (e.g., quad-rank, octal-rank, multi-bank, etc.), it thus also contemplates different arrangements for the respective codes. For example, in an octal-rank memory subsystem, a particular code value may indicate that some data may be mirrored to two or more (but not necessarily all) ranks. Furthermore, a particular code value may indicate that error checking is to be carried out via a voting scheme in which data is read from three or more ranks, with the various copies compared such that, if all but one of copy of the data has the same value, the copy that is different is determined to be erroneous. In some embodiments, logic outside the memory controller may also be present (e.g., in a processor core) that determines which ranks on which data is to be duplicated.

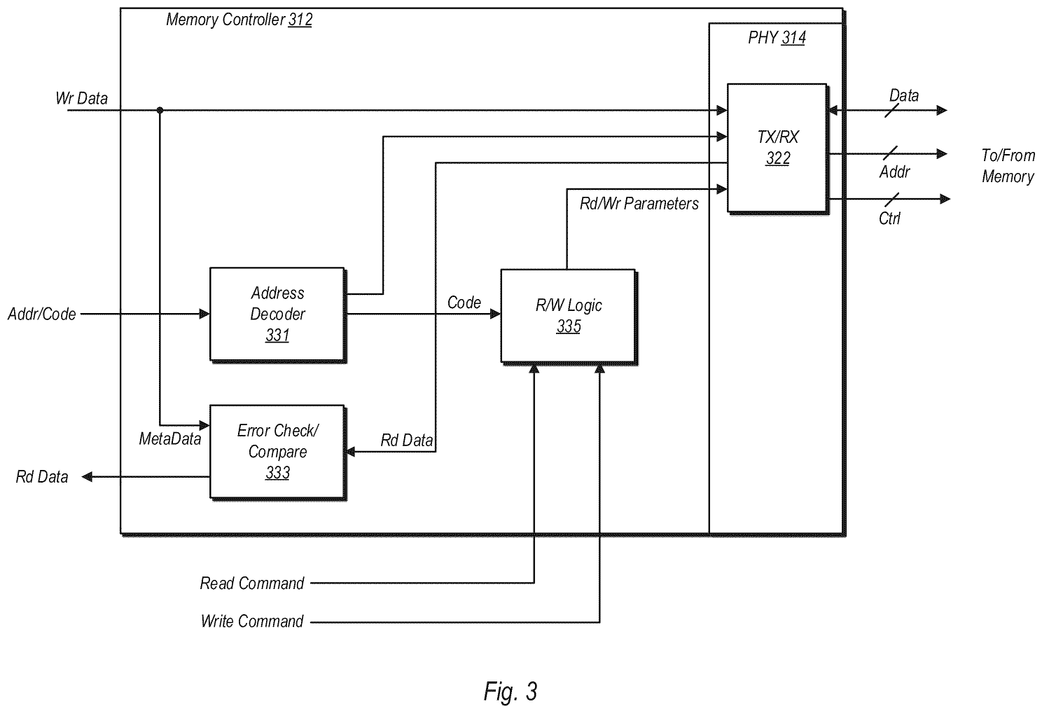

FIG. 3 is a block diagram of one embodiment of a memory controller. In the embodiment shown, memory controller 312 is configured to support mirroring of data in a multi-rank memory subsystem as discussed above. Memory controller 312 includes an address decoder 331, error checking/compare logic 333, read/write logic 335, and a physical interface 314 that includes transceiver 322.

Address decoder 331 in the embodiment shown is configured to decode a received address and extract a code therefrom, the code being used to determine read parameters (when the address is associated with a read command) or write parameters (when the address is associated with a write command). The code is forwarded to read/write logic 335, which is coupled to receive read and write commands. Read/write logic 335 generates read parameters for codes associated with read commands, and write parameters for codes associated with write commands. These parameters are forwarded to transceiver 322.

Transceiver 322 in the embodiment shown generates corresponding control signals (e.g., read enable signals, write enable signals, etc.) to carry out the commands received by memory controller 312. Furthermore, transceiver 322 drives address signals to the memory for both read and write operations. For write operations, transceiver 322 transmits data to the memory. For read operations, transceiver 322 receives data from the memory.

During at least some read operations (depending on the value of the code) data read from memory is forwarded to error check/compare logic 333. This logic unit may perform comparisons of data read from two different ranks in a multi-rank memory subsystem, and may perform error checking using various mechanisms. For example, metadata received when the corresponding data is initially written to memory may be stored in registers in error check/compare logic and accessed for error detection operations. Error detection may also be carried out using checksums or ECCs. In multi-rank memory subsystems extending beyond dual-rank, error check/compare logic may support voting schemes in which copies of data read from multiple ranks are compared to one another to determine if errors are present as well as to determine its correct value. Error check/compare logic 333 is also configured to provide data from memory controller 312 to a requestor to complete execution of a read command.

### Methods of Operation

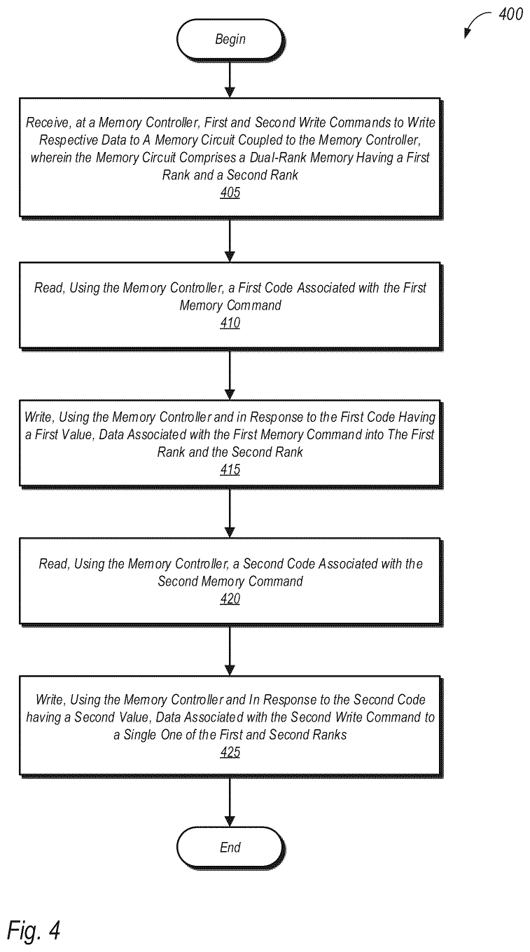

FIG. 4 is a flow diagram of one embodiment of a method for operating a memory subsystem. Method 400 may be carried out in various embodiments of a memory subsystem in accordance with the disclosure. Embodiments of a memory subsystem capable of carrying out Method 400 but not otherwise discussed herein is considered to fall within the scope of this disclosure.

Method 400 includes receiving, at a memory controller, first and second write commands to write respective data to a memory circuit coupled to the memory controller, wherein the memory circuit comprises a dual-rank memory having a first rank and a second ranks separately addressable from one another (block 405). The method further includes reading, using the memory controller, a first code associated with the first write command (block 410) and writing, using the memory controller and in response the first code having a first value, data associated with the first write command into the first rank and the second rank (block 415). The method also includes reading, using the memory controller, a second code associated with the second write command (block 420) and writing, using the memory controller and in response the second code having a second value, data associated with the second write command to a single one of the first and second ranks (block 425).

Some embodiments of the method includes decoding a first address associated with the first write command, wherein a subset of bits of the first address comprises the first code and decoding a second address associated with the second write command, wherein a subset of bits of the second address comprises the second code.

Various embodiments of Method 400 include determining, by the memory controller, one or more read parameters for data associated with the first write command based on the first value, wherein the one or more read parameters include determining from which of the first and second ranks the data associated with the first write command is to be read. The read parameters may also include expected read latencies, and thus the method may include selecting, by the memory controller, one of the first or second ranks from which data associated with the first write command is to be read based on expected read latencies. Read parameters may also specify the data is to be checked for accuracy. Accordingly, embodiments of the method may include reading the data associated with the first write command from the first rank and from the second rank and performing a comparison of the data associated with the first write command as read from the first rank and the second rank to determine a presence of an error.

Data written to two or more ranks in carrying out Method 400 may be considered to be data having error protection. The method further includes forgoing error protection for data associated with the second write command, as the data associated with this command is written to only a single rank.

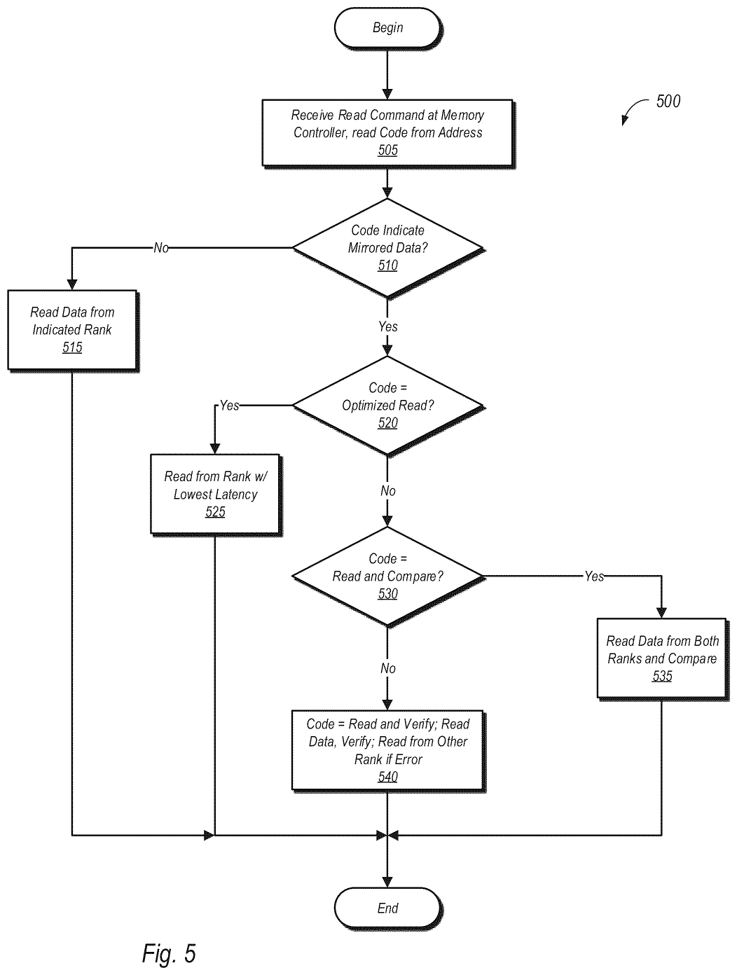

FIG. 5 is a flow diagram of another embodiment of a method for operating a memory subsystem. Method 500 as shown in FIG. 5 and discussed herein may be carried out by various embodiments of a memory subsystem as discussed elsewhere herein. Embodiments of a memory subsystem capable of carrying out Method 500 but not otherwise discussed herein are also considered to fall within the scope of this disclosure.

Method 500 includes receiving a read command at a memory controller and reading a code from the address (block 505). The code may be included in extra bits of the memory address, such as RAS (row address strobe) or otherwise unused bits. The code may take on various values that indicate whether the data is to be mirrored (replicated in another rank or other portion of memory) as well as how the data is to be read in the event that it is mirrored. If the code indicates that the data is not mirrored (block 510, no), the requested data is read from its location in memory in, e.g., the indicated rank (block 515).

If the code indicates that the data is mirrored (block, 510), the data may be read in accordance with read parameters indicated thereby. If the code indicates that the read is to be optimized for latency (block 520, yes), then the data is read from the rank with the lowest estimated latency (block 525). Determining the rank with the lowest latency may be carried out in various ways. For example, in a dual-rank system which supports the memory controller concurrently accessing both ranks, the data may be read from a rank with no requests pending or fewer requests in the queue in front of the read command. Embodiments are also possible and contemplated in which one rank is generally able to support lower latency reads than the other, with this rank chosen by the memory controller in the absence of other pending memory access requests. In some embodiments, a memory controller may track read latency times and use this information to determine the rank from which the data is read. The disclosure further contemplates embodiments in which a combination of factors is used to determine the rank (or memory portion) with the lowest read latency in supporting optimized reads.

If the code does not indicate an optimized read (block 520, no) but indicates a read and compare operation is to be carried out (block 530, yes), then the data is read from both ranks and compared by comparison logic in the memory controller (block 535). The read and compare operation may be used to determine if an error is present in the data. If the data is found to be erroneous, additional operations may be carried out to locate and correct the error, if possible. It is noted that while the read and compare operation is described here for a dual-rank memory, the disclosure contemplates extending this operation to other memory arrangements, such as quad-rank or octal-rank memories. In such embodiments, error detection and correction may be carried out using more than two copies of the data, e.g., using voting. For example, in a quad-rank system, if three copies of the data are in agreement but a fourth copy is not, the fourth copy may be rewritten to match the other three in order to carry out a correction.

If the code does not indicate a read and compare operation (block 530, no), the code therefore indicates a read and verify operation (block 540) in this particular embodiment. The read and verify operation includes reading data from one of the ranks, verifying that it is error free (using, e.g., ECCs, metadata, a checksum, or another suitable mechanism). If an error is detected, the data is read from the other rank, and may also be checked for the presence of an error. This operation may also be implemented in embodiments that are, e.g., quad-rank or octal-rank memory subsystems.

### Example Device

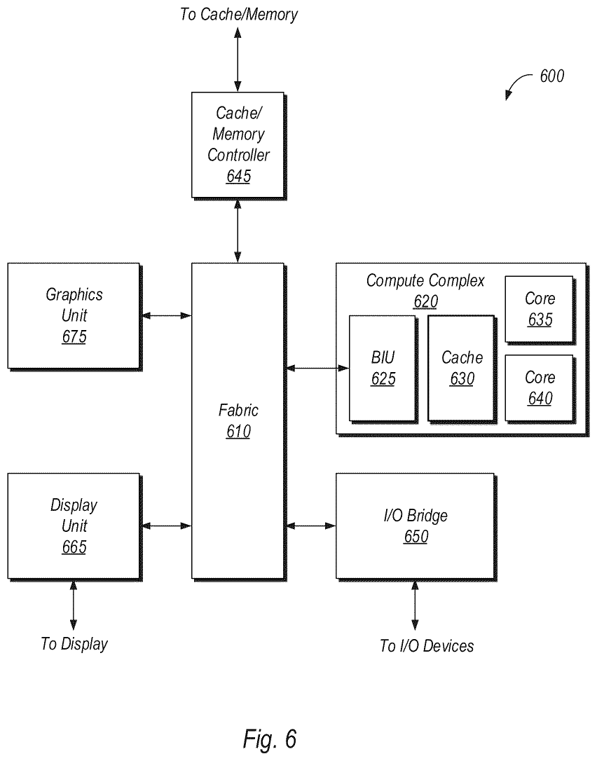

Referring now to FIG. 6, a block diagram illustrating an example embodiment of a device that may include a memory controller of a memory subsystem, as disclosed above. In some embodiments, elements of device 600 may be included within a system on a chip. In some embodiments, device 600 may be included in a mobile device, which may be battery-powered. Therefore, power consumption by device 600 may be an important design consideration. In the illustrated embodiment, device 600 includes fabric 610, compute complex 620, input/output (I/O) bridge 650, cache/memory controller 645, graphics unit 675, and display unit 665. In some embodiments, device 600 may include other components (not shown) in addition to, or in place of, the illustrated components, such as video processor encoders and decoders, image processing or recognition elements, computer vision elements, etc.

Fabric 610 may include various interconnects, buses, MUX's, controllers, etc., and may be configured to facilitate communication between various elements of device 600. In some embodiments, portions of fabric 610 may be configured to implement various different communication protocols. In other embodiments, fabric 610 may implement a single communication protocol, and elements coupled to fabric 610 may convert from the single communication protocol to other communication protocols internally.

In the illustrated embodiment, compute complex 620 includes bus interface unit (BIU) 625, cache 630, and cores 635 and 640. In various embodiments, compute complex 620 may include various numbers of processors, processor cores, and caches. For example, compute complex 620 may include 1, 2, or 4 processor cores, or any other suitable number. In one embodiment, cache 630 is a set associative L2 cache. In some embodiments, cores 635 and 640 may include internal instruction and data caches. In some embodiments, a coherency unit (not shown) in fabric 610, cache 630, or elsewhere in device 600, may be configured to maintain coherency between various caches of device 600. BIU 625 may be configured to manage communication between compute complex 620 and other elements of device 600. Processor cores, such as cores 635 and 640, may be configured to execute instructions of a particular instruction set architecture (ISA) which may include operating system instructions and user application instructions. These instructions may be stored in a computer readable medium such as a memory coupled to cache memory controller 645 as discussed below.

As used herein, the term “coupled to” may indicate one or more connections between elements, and a coupling may include intervening elements. For example, in FIG. 6, graphics unit 675 may be described as “coupled to” a memory through fabric 610 and cache/memory controller 645. In contrast, in the illustrated embodiment of FIG. 6, graphics unit 675 is “directly coupled” to fabric 610 because there are no intervening elements.

Cache/memory controller 645 may be configured to manage transfer of data between fabric 610 and one or more caches and memories. For example, cache/memory controller 645 may be coupled to an L3 cache, which may, in turn, be coupled to a system memory. In other embodiments, cache/memory controller 645 may be directly coupled to a memory. In some embodiments, cache/memory controller 645 may include one or more internal caches. Memory coupled to cache/memory controller 645 may be any type of volatile memory, such as dynamic random access memory (DRAM), synchronous DRAM (SDRAM), double data rate (DDR, DDR2, DDR3, etc.) SDRAM (including mobile versions of SDRAMs such as mDDR3, etc., and/or low power versions of SDRAMs such as LPDDR4, etc.), RAMBUS DRAM (RDRAM), static RAM (SRAM), etc. One or more memory devices may be coupled onto a circuit board to form memory modules such as single inline memory modules (SIMMs), dual inline memory modules (DIMMs), etc. Alternatively, the devices may be mounted with an integrated circuit in a chip-on-chip configuration, a package-on-package configuration, or a multi-chip module configuration. Memory coupled to cache/memory controller 645 may be any type of non-volatile memory such as NAND flash memory, NOR flash memory, nano RAM (NRAM), magneto-resistive RAM (MRAM), phase change RAM (PRAM), Racetrack memory, Memristor memory, etc. As noted above, this memory may store program instructions executable by compute complex 620 to cause the computing device to perform functionality described herein.

Graphics unit 675 may include one or more processors, e.g., one or more graphics processing units (GPUs). Graphics unit 675 may receive graphics-oriented instructions, such as OPENGL®, Metal®, or DIRECT3D® instructions, for example. Graphics unit 675 may execute specialized GPU instructions or perform other operations based on the received graphics-oriented instructions. Graphics unit 675 may generally be configured to process large blocks of data in parallel, and may build images in a frame buffer for output to a display, which may be included in the device or may be a separate device. Graphics unit 675 may include transform, lighting, triangle, and rendering engines in one or more graphics processing pipelines. Graphics unit 675 may output pixel information for display images. Graphics unit 675, in various embodiments, may include programmable shader circuitry which may include highly parallel execution cores configured to execute graphics programs, which may include pixel tasks, vertex tasks, and compute tasks (which may or may not be graphics-related).

Display unit 665 may be configured to read data from a frame buffer and provide a stream of pixel values for display. Display unit 665 may be configured as a display pipeline in some embodiments. Additionally, display unit 665 may be configured to blend multiple frames to produce an output frame. Further, display unit 665 may include one or more interfaces (e.g., MIPI® or embedded display port (eDP)) for coupling to a user display (e.g., a touchscreen or an external display).

I/O bridge 650 may include various elements configured to implement universal serial bus (USB) communications, security, audio, and low-power always-on functionality, for example. I/O bridge 650 may also include interfaces such as pulse-width modulation (PWM), general-purpose input/output (GPIO), serial peripheral interface (SPI), and inter-integrated circuit (I2C), for example. Various types of peripherals and devices may be coupled to device 600 via I/O bridge 850.

In some embodiments, device 600 includes network interface circuitry (not explicitly shown), which may be connected to fabric 910 or I/O bridge 650. The network interface circuitry may be configured to communicate via various networks, which may be wired, wireless, or both. For example, the network interface circuitry may be configured to communicate via a wired local area network, a wireless local area network (e.g., via Wi-Fi™), or a wide area network (e.g., the Internet or a virtual private network). In some embodiments, the network interface circuitry is configured to communicate via one or more cellular networks that use one or more radio access technologies. In some embodiments, the network interface circuitry is configured to communicate using device-to-device communications (e.g., Bluetooth® or Wi-Fi™ Direct), etc. In various embodiments, the network interface circuitry may provide device 600 with connectivity to various types of other devices and networks.

### System Application Examples

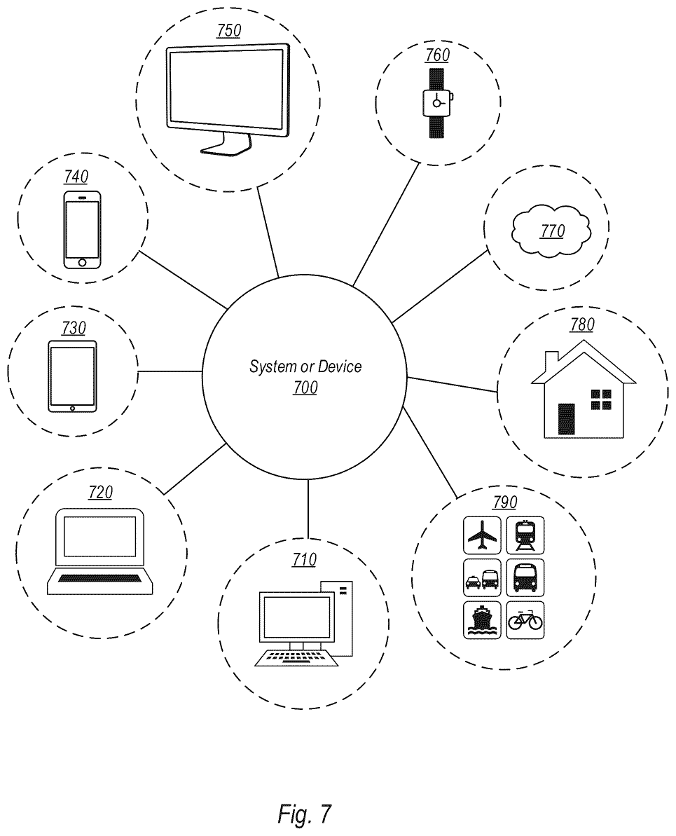

Turning now to FIG. 7, various types of systems that may include any of the circuits, devices, or systems discussed above are illustrated. System or device 700, which may incorporate or otherwise utilize one or more of the techniques described herein, may be utilized in a wide range of areas. For example, system or device 700 may be utilized as part of the hardware of systems such as a desktop computer 710, laptop computer 720, tablet computer 730, cellular or mobile phone 740, or television 750 (or set-top box coupled to a television).

Similarly, disclosed elements may be utilized in a wearable device 760, such as a smartwatch or a health-monitoring device. Smartwatches, in many embodiments, may implement a variety of different functions—for example, access to email, cellular service, calendar, health monitoring, etc. A wearable device may also be designed solely to perform health-monitoring functions, such as monitoring a user's vital signs, performing epidemiological functions such as contact tracing, providing communication to an emergency medical service, etc. Other types of devices are also contemplated, including devices worn on the neck, devices implantable in the human body, glasses or a helmet designed to provide computer-generated reality experiences such as those based on augmented and/or virtual reality, etc.

System or device 700 may also be used in various other contexts. For example, system or device 700 may be utilized in the context of a server computer system, such as a dedicated server or on shared hardware that implements a cloud-based service 770. Still further, system or device 700 may be implemented in a wide range of specialized everyday devices, including devices 780 commonly found in the home such as refrigerators, thermostats, security cameras, etc. The interconnection of such devices is often referred to as the “Internet of Things” (IoT). Elements may also be implemented in various modes of transportation. For example, system or device 700 could be employed in the control systems, guidance systems, entertainment systems, etc. of various types of vehicles 760.

The applications illustrated in FIG. 7 are merely exemplary and are not intended to limit the potential future applications of disclosed systems or devices. Other example applications include, without limitation: portable gaming devices, music players, data storage devices, unmanned aerial vehicles, etc.

The present disclosure has described various example circuits in detail above. It is intended that the present disclosure cover not only embodiments that include such circuitry, but also a computer-readable storage medium that includes design information that specifies such circuitry. Accordingly, the present disclosure is intended to support claims that cover not only an apparatus that includes the disclosed circuitry, but also a storage medium that specifies the circuitry in a format that programs a computing system to generate a simulation model of the hardware circuit, programs a fabrication system configured to produce hardware (e.g., an integrated circuit) that includes the disclosed circuitry, etc. Claims to such a storage medium are intended to cover, for example, an entity that produces a circuit design, but does not itself perform complete operations such as design simulation, design synthesis, circuit fabrication, etc.

### Computer Readable Medium

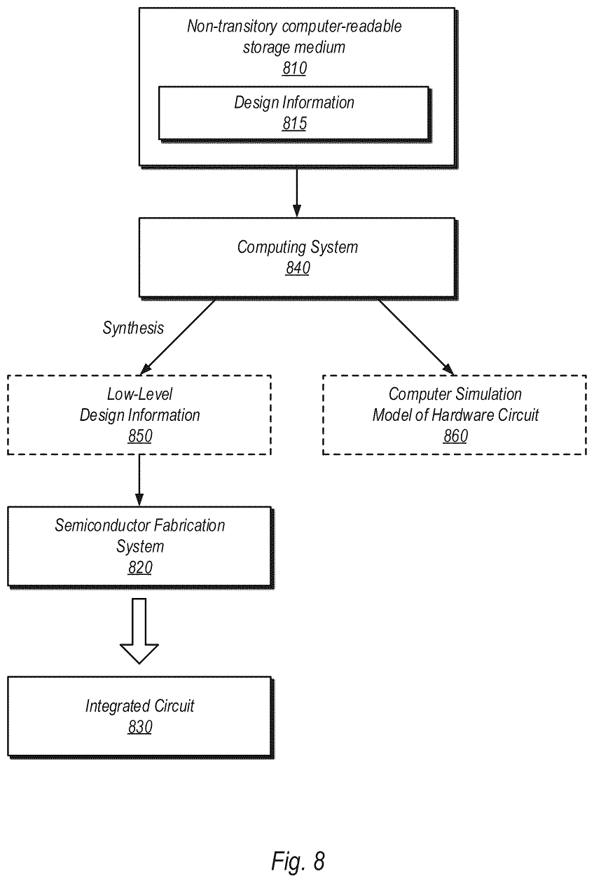

FIG. 8 is a block diagram illustrating an example of a non-transitory computer-readable storage medium that stores design information 815, according to some embodiments. In the illustrated embodiment, computing system 840 is configured to process design information 815. This may include executing instructions included in design information 815, interpreting instructions included in design information 815, compiling, transforming, or otherwise updating design information 815, etc. Therefore, design information 815 controls computing system 840 (e.g., by programming computing system 840) to perform various operations discussed below, in some embodiments.

In the illustrated example, computing system 840 processes design information 815 to generate both computer simulation model of hardware circuit 860 and low-level design information 850. In other embodiments, computing system 840 may generate only one of these outputs, may generate other outputs based on design information 815, or both. Regarding computer simulation model of hardware circuit 860, computing system 840 may execute instructions of a hardware description language that includes register transfer level (RTL) code, behavioral code, structural code, or some combination thereof. The simulation model may perform the functionality specified by design information 815, facilitate verification of the functional correctness of the hardware design, generate power consumption estimates, generate timing estimates, etc.

In the illustrated example, computing system 840 also processes design information 815 to generate low-level design information 850 (e.g., gate-level design information, a netlist, etc.). This may include synthesis operations, as shown, such as constructing a multi-level network, optimizing the network using technology-independent techniques, technology dependent techniques, or both, and outputting a network of gates (with potential constraints based on available gates in a technology library, sizing, delay, power, etc.). Based on low-level design information 850 (potentially among other inputs), semiconductor fabrication system 820 is configured to fabricate integrated circuit 830 (which may correspond to functionality of the computer simulation model of hardware circuit 860). Note that computing system 840 may generate different simulation models based on design information at various levels of description, including low-level design information 850, design information 815, and so on. The data representing low-level design information 850 and computer simulation model of hardware circuit 860 may be stored on non-transitory computer-readable storage medium 810, or on one or more other media.

In some embodiments, low-level design information 850 controls (e.g., programs) semiconductor fabrication system 820 to fabricate integrated circuit 830. Thus, when processed by the fabrication system, the design information may program the fabrication system to fabricate a circuit that includes various circuitry disclosed herein.

Non-transitory computer-readable storage medium 810 may comprise any of various appropriate types of memory devices or storage devices. Non-transitory computer-readable storage medium 810 may be an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash memory, magnetic media, e.g., a hard drive, or optical storage; registers, or other similar types of memory elements, etc. Non-transitory computer-readable storage medium 810 may include other types of non-transitory memory as well, or combinations thereof. Accordingly, non-transitory computer-readable storage medium 1010 may include two or more memory media, which may reside in different locations for example, in different computer systems that are connected over a network.

Design information 815 may be specified using any of various appropriate computer languages, including hardware description languages such as, without limitation: VHDL, Verilog, SystemC, SystemVerilog, RHDL, M, MyHDL, etc. The format of various design information may be recognized by one or more applications executed by computing system 840, semiconductor fabrication system 820, or both. In some embodiments, design information 815 may also include one or more cell libraries that specify the synthesis, layout, or both of integrated circuit 830. In some embodiments, design information 815 is specified in whole, or in part, in the form of a netlist that specifies cell library elements and their connectivity. Design information discussed herein, taken alone, may or may not include sufficient information for fabrication of a corresponding integrated circuit. For example, design information may specify the circuit elements to be fabricated but not their physical layout. In this case, design information may be combined with layout information to actually fabricate the specified circuitry.

Integrated circuit 830 may, in various embodiments, include one or more custom macrocells, such as memories, analog or mixed-signal circuits, and the like. In such cases, design information 815 may include information related to included macrocells. Such information may include, without limitation, schematics capture database, mask design data, behavioral models, and device or transistor level netlists. Mask design data may be formatted according to graphic data system (GDSII), or any other suitable format.

Semiconductor fabrication system 820 may include any of various appropriate elements configured to fabricate integrated circuits. This may include, for example, elements for depositing semiconductor materials (e.g., on a wafer, which may include masking), removing materials, altering the shape of deposited materials, modifying materials (e.g., by doping materials or modifying dielectric constants using ultraviolet processing), etc. Semiconductor fabrication system 820 may also be configured to perform various testing of fabricated circuits for correct operation.

In various embodiments, integrated circuit 830 and computer simulation model of hardware circuit 860 are configured to operate according to a circuit design specified by design information 815, which may include performing any of the functionality described herein. For example, integrated circuit 830 may include any of various elements shown in FIG. 1-7. Further, integrated circuit 830 may be configured to perform various functions described herein in conjunction with other components. Further, the functionality described herein may be performed by multiple connected integrated circuits.

As used herein, a phrase of the form “design information that specifies a design of a circuit configured to . . . ” does not imply that the circuit in question must be fabricated in order for the element to be met. Rather, this phrase indicates that the design information describes a circuit that, upon being fabricated, will be configured to perform the indicated actions or will include the specified components. Similarly, stating “instructions of a hardware description programming language” that are “executable” to program a computing system to generate a computer simulation model does not imply that the instructions must be executed in order for the element to be met, but rather, specifies characteristics of the instructions. Additional features relating to the model (or the circuit represented by the model) may similarly relate to characteristics of the instructions, in this context. Therefore, an entity that sells a computer-readable medium with instructions that satisfy recited characteristics may provide an infringing product, even if another entity actually executes the instructions on the medium.

Note that a given design, at least in the digital logic context, may be implemented using a multitude of different gate arrangements, circuit technologies, etc. As one example, different designs may select or connect gates based on design tradeoffs (e.g., to focus on power consumption, performance, circuit area, etc.). Further, different manufacturers may have proprietary libraries, gate designs, physical gate implementations, etc. Different entities may also use different tools to process design information at various layers (e.g., from behavioral specifications to physical layout of gates).

Once a digital logic design is specified, however, those skilled in the art need not perform substantial experimentation or research to determine those implementations. Rather, those of skill in the art understand procedures to reliably and predictably produce one or more circuit implementations that provide the function described by design information 815. The different circuit implementations may affect the performance, area, power consumption, etc. of a given design (potentially with tradeoffs between different design goals), but the logical function does not vary among the different circuit implementations of the same circuit design.

In some embodiments, the instructions included in design information 815 provide RTL information (or other higher-level design information) and are executable by the computing system to synthesize a gate-level netlist that represents the hardware circuit based on the RTL information as an input. Similarly, the instructions may provide behavioral information and be executable by the computing system to synthesize a netlist or other lower-level design information included in low-level design information 850. Low-level design information 850 may program semiconductor fabrication system 820 to fabricate integrated circuit 830.

The present disclosure includes references to an “embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more of the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent claims that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more. ” Reference to “an item” in a claim thus does not, without accompanying context, preclude additional instances of the item. A “plurality”of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or”is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third,” when applied to a feature, do not imply any type of ordering (e.g., spatial, temporal, logical, etc.), unless stated otherwise.

The phrase “based on” is used to describe one or more factors that affect a determination. This term does not foreclose the possibility that additional factors may affect the determination. That is, a determination may be solely based on specified factors, or based on the specified factors as well as other, unspecified factors. Consider the phrase “determine A based on B. ” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on. ”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B. ” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to. ” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, a circuit, or a system having a processor unit and a memory storing program instructions executable to implement the task, etc. This phrase is not used herein to refer to something intangible.

In some cases, various units/circuits/components may be described herein as performing a set of tasks or operations. It is understood that those entities are “configured to” perform those tasks/operations, even if not specifically noted.

The term “configured to” is not intended to mean “configurable to. ” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S. C. § 112(f) for that claim element. Should Applicant wish to invoke Section 112(f) during prosecution of a United States patent application based on this disclosure, it will recite claim elements using the “means for” [performing a function] construct.

Different “circuits” may be described in this disclosure. These circuits or “circuitry” constitute hardware that includes various types of circuit elements, such as combinatorial logic, clocked storage devices (e.g., flip-flops, registers, latches, etc.), finite state machines, memory (e.g., random-access memory, embedded dynamic random-access memory), programmable logic arrays, and so on. Circuitry may be custom designed, or taken from standard libraries. In various implementations, circuitry can, as appropriate, include digital components, analog components, or a combination of both. Certain types of circuits may be commonly referred to as “units” (e.g., a decode unit, an arithmetic logic unit (ALU), a functional unit, a memory management unit (MMU), etc.). Such units also refer to circuits or circuitry.

The disclosed circuits/units/components and other elements illustrated in the drawings and described herein thus include hardware elements such as those described in the preceding paragraph. In many instances, the internal arrangement of hardware elements within a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

In various embodiments, as discussed in the preceding paragraph, circuits, units, and other elements may be defined by the functions or operations that they are configured to implement. The arrangement of such circuits/units/components with respect to each other and the manner in which they interact form a microarchitectural definition of the hardware that is ultimately manufactured in an integrated circuit or programmed into an FPGA to form a physical implementation of the microarchitectural definition. Thus, the microarchitectural definition is recognized by those of skill in the art as a structure from which many physical implementations may be derived, all of which fall into the broader structure described by the microarchitectural definition. That is, a skilled artisan presented with the microarchitectural definition supplied in accordance with this disclosure may, without undue experimentation and with the application of ordinary skill, implement the structure by coding the description of the circuits/units/components in a hardware description language (HDL) such as Verilog or VHDL. The HDL description is often expressed in a fashion that may appear to be functional. But to those of skill in the art in this field, this HDL description is the manner that is used to transform the structure of a circuit, unit, or component to the next level of implementational detail. Such an HDL description may take the form of behavioral code (which is typically not synthesizable), register transfer language (RTL) code (which, in contrast to behavioral code, is typically synthesizable), or structural code (e.g., a netlist specifying logic gates and their connectivity). The HDL description may subsequently be synthesized against a library of cells designed for a given integrated circuit fabrication technology, and may be modified for timing, power, and other reasons to result in a final design database that is transmitted to a foundry to generate masks and ultimately produce the integrated circuit. Some hardware circuits, or portions thereof, may also be custom-designed in a schematic editor and captured into the integrated circuit design along with synthesized circuitry. The integrated circuits may include transistors and other circuit elements (e.g., passive elements such as capacitors, resistors, inductors, etc.) and interconnect between the transistors and circuit elements. Some embodiments may implement multiple integrated circuits coupled together to implement the hardware circuits, and/or discrete elements may be used in some embodiments. Alternatively, the HDL design may be synthesized to a programmable logic array such as a field programmable gate array (FPGA) and may be implemented in the FPGA. This decoupling between the design of a group of circuits and the subsequent low-level implementation of these circuits commonly results in the scenario in which the circuit or logic designer never specifies a particular set of structures for the low-level implementation beyond a description of what the circuit is configured to do, as this process is performed at a different stage of the circuit implementation process.

The fact that many different low-level combinations of circuit elements may be used to implement the same specification of a circuit results in a large number of equivalent structures for that circuit. As noted, these low-level circuit implementations may vary according to changes in the fabrication technology, the foundry selected to manufacture the integrated circuit, the library of cells provided for a particular project, etc. In many cases, the choices made by different design tools or methodologies to produce these different implementations may be arbitrary.

Moreover, it is common for a single implementation of a particular functional specification of a circuit to include, for a given embodiment, a large number of devices (e.g., millions of transistors). Accordingly, the sheer volume of this information makes it impractical to provide a full recitation of the low-level structure used to implement a single embodiment, let alone the vast array of equivalent possible implementations. For this reason, the present disclosure describes structure of circuits using the functional shorthand commonly employed in the industry.

What is claimed is:

1. A system comprising:
a memory controller; and
a memory circuit coupled to the memory controller, wherein the memory circuit comprises a dual-rank memory having a first rank and a second rank separately addressable from one another;
wherein the memory controller is configured to:
receive a first write command and a second write command;
read a first code associated with the first write command;
in response to a determination of the first code having a first value, write data associated with the first write command to the first rank and the second rank;
read a second code associated with the second write command; and
in response to a determination of the second code having a second value, write the data associated with the second write command to a single one of first and second ranks.

2. The system of claim 1, wherein the memory controller is further configured to, in response to receiving a read command to read the data associated with the first write command, determine whether to, based on the first value, read the data from a particular one of the first or second ranks depending on estimated respective latencies of reading the data from the first and second ranks.

3. The system of claim 1, wherein the memory controller is further configured to, in response to receiving a read command to read the data associated with the first write command, and based determining the first code has the first value:
read the data associated with the first write command from the first rank and the second rank; and
compare the data associated with the first write command as read from the first rank to the data associated with the first write command as read from the second rank.

4. The system of claim 1, wherein the memory controller is further configured to, in response to receiving a read command to read the data associated with the first write command, and based on the first value:
read the data associated with the first write command from one the first rank;
determine a presence of an error in the data associated with the first write command; and
in response to determining the presence of the error, read the data associated with the first write command from the second rank.

5. The system of claim 4, wherein, to determine the presence of the error, the memory controller is configured to compare a checksum of the data associated with the first write command to a known checksum value.

6. The system of claim 1, wherein the memory controller is further configured to forego providing error protection to the data associated with the second write command in response to the second code having the second value.

7. The system of claim 1, wherein the memory controller is further configured to:
receive metadata associated with the first write command; and
perform error checking, using the metadata, on a subsequent read of the data associated with the first write command.

8. The system of claim 1, wherein the memory controller is configured to determine whether to, on a command-by-command basis, write respective data associated with ones of a plurality of write commands to the first rank and the second rank.

9. The system of claim 1, wherein the memory controller is configured to, for a given write command, decode an address comprising a first plurality of bits and a second plurality of bits, wherein the first plurality of bits of the address indicates a location within the memory circuit in which data associated with the given write command is to be stored, and wherein the second plurality bits associated with the given write command indicate whether the data associated with the given write command is to be stored in both the first and second ranks.

10. The system of claim 9, in response to receiving a given read command corresponding to the given write command, the memory controller is configured to determine, based on the second plurality of bits, one or more parameters for reading the data associated with the given write command from the memory circuit.

11. A method comprising:
receiving, at a memory controller, first and second write commands to write respective data to a memory circuit coupled to the memory controller, wherein the memory circuit comprises a dual-rank memory having a first rank and a second ranks separately addressable from one another;
reading, using the memory controller, a first code associated with the first write command;
writing, using the memory controller and in response the first code having a first value, data associated with the first write command into the first rank and the second rank;
reading, using the memory controller, a second code associated with the second write command; and
writing, using the memory controller and in response the second code having a second value, data associated with the second write command to a single one of the first and second ranks.

12. The method of claim 11, further comprising:
decoding a first address associated with the first write command, wherein a subset of bits of the first address comprises the first code; and
decoding a second address associated with the second write command, wherein a subset of bits of the second address comprises the second code.

13. The method of claim 11, further comprising:
determining, by the memory controller, one or more read parameters for data associated with the first write command based on the first value, wherein the one or more read parameters include determining from which of the first and second ranks the data associated with the first write command is to be read.

14. The method of claim 13, further comprising:
selecting, by the memory controller, one of the first or second ranks from which data associated with the first write command is to be read based on expected read latencies.

15. The method of claim 13, further comprising:
reading the data associated with the first write command from the first rank and from the second rank; and
performing a comparison of the data associated with the first write command as read from the first rank and the second rank to determine a presence of an error.

16. The method of claim 11, further comprising forgoing error protection for data associated with the second write command.

17. A system comprising:
a memory controller; and
a memory circuit coupled to the memory controller, wherein the memory circuit includes a plurality of memory portions separately addressable from one another;
wherein the memory controller is configured to:
receive a first write command and a second write command;
read a first code associated with the first write command;
in response to a determination of the first code having a first value, write data associated with the first write command to multiple ones of the plurality of memory portions;
read a second code associated with the second write command; and
in response to a determination of the second code having a second value, write the data associated with the second write command to a single one of the plurality of memory portions.

18. The system of claim 17, wherein the memory controller is further configured to:
decode, for the first write command, an address comprising a first plurality of bits and a second plurality of bits, wherein the first plurality of bits of the address indicates a location within the memory circuit in which data associated with the given write command is to be stored, and wherein the second plurality bits associated with the first write command indicate whether the data associated with the given write command is to be stored in multiple ones of the plurality of memory portions; and
determine, in response to receiving a read command corresponding to the given write command, based on the second plurality of bits, one or more parameters for reading the data associated with the given write command from the memory circuit.

19. The system of claim 18, wherein the one or more parameters for reading the data include a number of the plurality of memory portions from which data associated with the given write command is to be read.

20. The system of claim 18, wherein the one or more parameters for reading the data include which, based on an estimated read latency, of the plurality of memory portions from which data associated with the given write command is to be read.
